(19) United States
(12) Patent Application Publication
(10) Pub. No.: US 2017/0250001 A1
(43) Pub. Date: Aug. 31, 2017

(54) ELECTRICAL INSULATING MATERIAL AND METHOD FOR PREPARING INSULATING MATERIAL ELEMENT

(71) Applicant: ABB Schweiz AG, Baden (CH)

(72) Inventors: Fumei Wu, Beijing (CN); Xiaobing Dong, Beijing (CN); Henrik Hillborg, Västerås (SE); Jiansheng Chen, Beijing (CN); Jens Rocks, Freienbach (CH); Minghai Fu, Fujian (CN); Shuhui Wang, Fujian (CN); Yinglei Weng, Fujian (CN)

(21) Appl. No.: 15/593,868

(22) Filed: May 12, 2017

Related U.S. Application Data
(63) Continuation of application No. PCT/CN2014/090922, filed on Nov. 12, 2014.

(51) Int. Cl. H01B 3/44; C08L 53/02

(52) U.S. Cl. CPC H01B 3/442; C08L 53/02

(57) ABSTRACT

Embodiments of the present disclosure provide an electrical insulating material and a method for preparing an electrical insulating element. The electrical insulating material contains matrix component, filler component and liquid hydrophobic component; wherein the matrix component comprises saturated styrenic block copolymer. The electrical insulating material based on saturated styrenic block copolymer has good UV resistivity, tracking and erosion resistance, thermal stability, and lower dielectric constant and dielectric loss. It is also easy and cheap for producing.

### FIELD OF INVENTION

Embodiments of the present disclosure relate to the field of an electrical insulating material, in particular to an electrical insulating material based on styrenic block copolymers, and a method for preparing an electrical insulating element.

### BACKGROUND ART

Currently, the common insulation materials are Ethylene-Propylene-Diene Monomer (EPDM), silicone rubber or epoxy resin. These materials have their disadvantages respectively. For EPDM, it requires a crosslinking step for manufacturing an insulator with this material, and EPDM has low hydrophobicity in the outdoor environment. Silicone rubber needs complex processing technology, involving crosslinking step, which increases the cost for production. For epoxy resin, the crosslinking step is also time consuming, and the epoxy resin products are also hard and brittle, and thus are easy to be destroyed during the process of setup or transportation.

It is desired to provide an electrical insulating material which is relatively cheap and easy for fabricating. Meanwhile, this electrical insulating material should meet the technical requirements for outdoor insulation, and have good mechanical and electrical properties.

### SUMMARY OF INVENTION

Now, it has been found that the above-mentioned problems can be overcome by a new electrical insulating material. This electrical insulating material contains matrix component, filler component and liquid hydrophobic component. The matrix component comprises saturated styrenic block copolymer.

According to an exemplary embodiment, the saturated styrenic block copolymer comprises styrene-ethylene-butylene-styrene block copolymer, i.e. SEBS, styrene-ethylene-propyl-styrene block copolymer, i.e. SEPS, or the mixture of SEBS and SEPS.

According to an exemplary embodiment, the amount of the filler component is at most 85% of the total weight of the electrical insulating material, preferably in the range from 5% to 85%, more preferably in the range from 40% to 80%, more preferably in the range from 50% to 80%, and most preferably in the range from 50% to 70%, of the total weight of the electrical insulating material.

According to an exemplary embodiment, the filler component comprises tracking and erosion resistance fillers.

According to an exemplary embodiment, the amount of the liquid hydrophobic component is in the range from 1%-15% of the total weight of the electrical insulating material, and the filler component further comprises fillers for absorbing the liquid hydrophobic component.

According to an exemplary embodiment, the tracking and erosion resistance fillers contain one or more material in the group consisting of: natural purified sands, silicon oxides, silicon hydroxides, aluminum oxides, aluminum hydroxides, titanium oxides, titanium hydroxides, zinc borate, zinc oxides, zinc hydroxides, silicates, silicon aluminosilicates and mineral carbonates.

According to an exemplary embodiment, the fillers for absorbing the liquid hydrophobic component contain one or more material in the group consisting of: geopolymers, nano silica, glass, mica, ceramic particles and organic fillers.

According to an exemplary embodiment, the filler component has an average grain size in the range from 1.0 μm to 200 μm, preferably in the range from 1 μm to 100 μm, and more preferably in the range from 5 μm to 50 μm, more preferably in the range from 5 μm to 40 μm, and most preferably in the range from 5 μm to 35 μm.

According to an exemplary embodiment, the electrical insulating material further contains additive component. The additive component can comprise at least one of the followings: antioxidants, compatibilizers, plasticizers tougheners and UV stabilizers. The amount of the additive component may be in the range from 0.1%-10% of the total weight of the electrical insulating material.

According to an exemplary embodiment, the liquid hydrophobic component contains one or more material in the group consisting of: liquid fluorinated or chlorinated hydrocarbons which contain —CH₂-units, —CHF-units, —CF₂-units, —CF₃-units, —CHCl-units, —C(Cl)₂-units, and/or —C(Cl)₃-units; and a cyclic, linear or branched liquid organopolysiloxane.

According to an exemplary embodiment, the liquid hydrophobic component has a viscosity in the range from 50 cSt to 10000 cSt, preferably in the range from 100 cSt to 10000 cSt, and most preferably in the range from 40 cSt to 1000 cSt, measured in accordance with DIN 53 019 at 20° C.

According to an exemplary embodiment, the liquid organopolysiloxane corresponds to the general fomula (III):

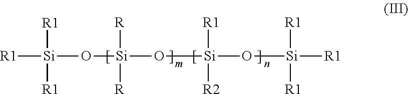

in which

R independently of each other is an unsubstituted or chlorinated or fluorinated alkyl radical having from 1 to 8 carbon atoms, (C1-C4- alkyl)aryl, or aryl;

R1 independently at each occurrence has one of the definitions of R or R2, it being possible for two terminal substitutes R1, attached to different Si atoms, being taken together to be an oxygen atom (=cyclic compound);

R2 has one of the definitions of R, or is hydrogen or a radical —A)r—CH═CH₂;

A is a radical —CsH₂s—, where

s is an integer from 1 to 6;

r is zero or one;

m is from zero to 5000;

n is from zero to 100;

The sum of [m+n] for non-cyclic compounds being at least 20, and the sequence of the groups —[Si(R)(R)O]— and —[Si(R1)(R2)O]— in the molecule being arbitrary.

According to an exemplary embodiment, the amount of the liquid organopolysiloxane is in the range from 0.1%-15% of the total weight of the electrical insulating material, preferably in the range from 0.25% to 10%, and most preferably in the range from 5% to 10%, of the total weight of the electrical insulating material.

According to an exemplary embodiment, a method for preparing an electrical insulating element with the electrical insulating material as mentioned above is provided, comprising the steps: a) mixing each component of the electrical insulating material in any desired sequence to get a mixture; b) putting the mixture from step a) into a Brabender mixer or extruder to be blended in a molten state, c) cutting the mixture from step b) into pellets; and d) putting the pellets from step c) into an injection moulding machine to produce a desired shape of the electrical insulating element.

The electrical insulating material based on saturated styrenic block copolymer has good hydrophobilic properties, tracking and erosion resistance, and thermal stability. Meanwhile, it has lower dielectric constant and dielectric loss compared with silicone rubber. Furthermore, the cost of this material is much lower than silicone rubber. What is more important is the processing advantage. Since it is the thermoplastic material due to the component of saturated styrenic block copolymer, it can be processed by injection moulding or extrusion, which is much simpler and faster than the processing technology of silicone rubber where a crosslinking step is required. Therefore the cost for processing and final product could be greatly reduced.

### DETAILED DESCRIPTION OF EMBODIMENTS

Hereinafter, exemplary embodiments will be referred to in describing the mechanism and spirit of the present disclosure. It should be understood that these embodiments are merely provided to facilitate those skilled in the art in understanding and in turn implementing the present disclosure, but not for limiting the scope of the present disclosure in any way.

The electrical insulating material contains matrix component, filler component and liquid hydrophobic component. The matrix component comprises saturated styrenic block copolymers. The saturated styrenic block copolymers may be styrene-ethylene-butylene-styrene block copolymer, i.e. SEBS, styrene-ethylene-propyl-styrene block copolymer, i.e. SEPS, or the mixture of SEBS and SEPS.

The general formula of SEBS is shown as follows:

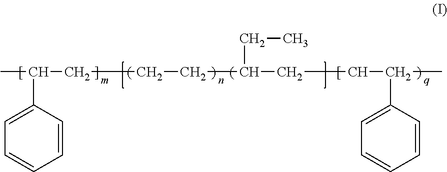

Wherein the indices of m, n, p and q can be any integral number, and the polymer comprise random copolymer blocks.

The general formula of SEPS is shown as follows:

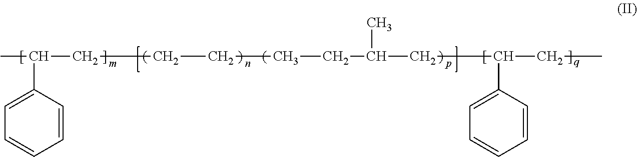

Wherein the indices of m, n, p and q can be any integral number, and the polymer comprise random copolymer blocks.

This kind of matrix material shows good flexibility properties, tensile strength properties, UV resistance properties, hydrophobicity properties, stability properties and aging resistance properties, and is suitable to act as a matrix material for an electrical insulating material.

In order to improve the dielectric properties, tracking and erosion resistance capacity, flame retardancy capacity, hydrophobicity recovery capacity and mechanical properties of the material, some fillers can be added into the electrical insulating material. The amount of the filler component is at most 85% of the total weight of the electrical insulating material, preferably in the range from 5% to 85%, more preferably in the range from 40% to 80%, more preferably in the range from 50% to 80%, and most preferably in the range from 50% to 70%, of the total weight of the electrical insulating material.

To improve the tracking and erosion resistance capacity, at least one of the following fillers can be added: natural purified sands, silicon oxides (such as dry silica powder), silicon hydroxides; aluminum oxides, aluminum hydroxides; titanium oxides, titanium hydroxides, zinc borate, zinc oxide, zinc hydroxides, silicates including sodium silicates and potassium silicates and silicon aluminosilicates, mineral carbonates including calcium-magnium carbonate and calcium-silicon-magnesium carbonates

To improve the hydrophobicity recovery of the material, some fillers can be added for adsorbing the liquid hydrophobic component. This kind of fillers can be selected from at least one of the followings: geopolymers including trolites and zeolites based on aluminosilicates or other alkaline earth metals , nano silica, glass, mica, ceramic particles and organic fillers, such as PTFE powder. This kind of fillers can maintain more liquid hydrophobic component in the material; such that even the liquid hydrophobic component on the outmost surface of the material is lost due to the severe environment (for example, due to the rinse of the rain or the removal by the dust), the liquid hydrophobic component absorbed in this filler can infiltrate the outmost surface of the material to recovery the hydrophobicity.

Other fillers can also be added to further improve the properties of the material in the above aspects and other aspects, such as the flame retardancy capacity and the mechanical properties. This kind of fillers can be selected from at least one of the followings: zinc oxides, zinc hydroxides, zinc borate, alumina trihydrate, mineral carbonates and other organic fillers.

For better hydrophobicity recovery capacity, the amount of the liquid hydrophobic component is in the range from 1%-15% of the total weight of the electrical insulating material. The amount of the fillers for adsorbing the liquid hydrophobic component can be generally equal to the amount of the liquid hydrophobic component by weight.

The filler component has an average grain size in the range from 1.0 μm to 200 μm, preferably in the range from 1 μm to 100 μm, and more preferably in the range from 5 μm to 50 μm, more preferably in the range from 5 μm to 40 μm, and most preferably in the range from

Spun to 35 μm. In addition, preferably, the grain size of at least 50% of the grains of the fillers is in the above range.

In an exemplary embodiment, the liquid hydrophobic component contains one or more material in the group consisting of: liquid fluorinated or chlorinated hydrocarbons which contain —CH₂-units, —CHF-units, —CF₂-units, —CF₃-units, —CHCl-units, —C(Cl)₂-units, and/or —C(Cl)₃-units; and a cyclic, linear or branched liquid organopolysiloxane (also called as silicone oil).

Preferably, the liquid hydrophobic component has a viscosity in the range from 50 cSt to 10000 cSt, preferably in the range from 100 cSt to 10000 cSt, and most preferably in the range from 40 cSt to 1000 cSt, measured in accordance with DIN 53 019 at 20° C.

Preferably, the liquid organopolysiloxane corresponds to the general fomula

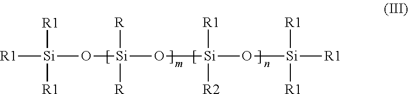

in which

R independently of each other is an unsubstituted or chlorinated or fluorinated alkyl radical having from 1 to 8 carbon atoms, (C1-C4- alkyl)aryl, or aryl;

R1 independently at each occurrence has one of the definitions of R or R2, it being possible for two terminal substitutes R1, attached to different Si atoms, being taken together to be an oxygen atom (=cyclic compound);

R2 has one of the definitions of R, or is hydrogen or a radical —(A)r—CH═CH₂;

A is a radical —CsH₂s—, where

s is an integer from 1 to 6;

r is zero or one;

in is from zero to 5000;

n is from zero to 100;

The sum of [m+n] for non-cyclic compounds being at least 20, and the sequence of the groups —[Si(R)(R)O]— and —[Si(R1)(R2)O]— in the molecule being arbitrary.

It is found that the combination of the organopolysiloxane and the geopolymers (particularly the trolites and zeolites based on aluminosilicates or other alkaline earth metals) in the electrical insulating material according to the present disclosure can significantly improve the hydrophobicity recovery of the material.

Preferably, the amount of the liquid organopolysiloxane is in the range from 0.1%-15% of the total weight of the electrical insulating material, preferably in the range from 0.25% to 10%, and most preferably in the range from 5% to 10%, of the total weight of the electrical insulating material.

Some additives can also be added into the electrical insulating material. The additive component can comprise at least one of the followings: antioxidants, compatibilizers, plasticizers, tougheners and UV stabilizers, which are well known in the art.

The amount of the additive component can be in the range from 0.1%-10% of the total weight of the electrical insulating material.

After incorporation of the liquid hydrophobic component, the filler component and the additive component, the amount of the matrix component based on styrenic block copolymers in the material may be up to 70% by weight.

The electrical insulating material according to the present disclosure can be used to produce an electrical insulating element. The method for preparing the electrical insulating element can comprise the steps: a) mixing each component of the electrical insulating material in any desired sequence to get a mixture; b) putting the mixture from step a) into a Brabender mixer or extruder to be blended in a molten state, c) cutting the mixture from step b) into pellets; and d) putting the pellets from step c) into an injection moulding machine to produce a desired shape of the electrical insulating element.

Preferred uses of the electrical insulating material and electrical insulating element produced according to the present disclosure are high-voltage insulations for outdoor use, especially for outdoor insulators associated with high-voltage lines, as long-rod, composite and cap-type insulators, and also for base insulators in the medium-voltage sector, in the production of insulators associated with outdoor power switches, measuring transducers, leadthroughs, and overvoltage protectors, in switchgear construction, in power switches, dry-type transformers, and electrical machines, as coating materials for transistors and other semiconductor elements and/or to impregnate electrical components. The present disclosure further refers to the electrical articles containing the electrical insulating elements according to the present disclosure. The following examples illustrate the disclosure.

### Example 1

A formulation is prepared from the following components: 100 parts SEBS; 140 parts Aluminium hydroxide; 40 parts of dry silica powder (2000 mesh); 20 parts silicone oil (10 parts 50 cSt and 10 parts 300 cSt); 20 parts zeolite powder (500 mesh); 0.3 parts antioxidant 1010 and 0.5 parts UV stabilizer LS791.

The mixing process is 1) All SEBS and fillers, additives were put into a conventional high speed mixer; 2) The mixture of a) was put into a Brabender mixer or an extruder to be blended in the molten state, and was cut into pellets; 3) The pellets from b) were put into an injection molding machine to be produced the desired shape of an electrical insulation element.

### Example 2

A formulation was prepared from the following components: 100 parts SEBS; 70 parts Aluminium hydroxide; 20 parts Zinc Borate; 3 parts fumed silica; 10 parts silicone oil (5 parts 50 cSt and 5 parts 500 cSt); 20 parts zeolite powder (500 mesh); 0.3 parts antioxidant 1076 and 0.5 parts UV stabilizer UV326. The mixing process is the same as Example 1.

### Example 3

A formulation was prepared from the following components: 100 parts SEPS; 140 parts Aluminium hydroxide; 40 parts of dry silica powder (2000 mesh); 20 parts silicone oil (10 parts 50 cSt and 10 parts 300 cSt); 20 parts zeolite powder (500 mesh); 0.3 parts antioxidant 1010 and 0.5 parts UV stabilizer LS791. The mixing process is the same as Example 1.

### Example 4

A formulation was prepared from the following components: 70 parts SEBS and 30 parts SEPS; 70 parts Aluminium hydroxide; 20 parts Zinc Borate; 3 parts fumed silica; 10 parts silicone oil (5 parts 50 cSt and 5 parts 500 cSt); 20 parts zeolite powder (500 mesh); 0.3 parts antioxidant 1076 and 0.5 parts UV stabilizer UV326. The mixing process is the same as Example 1.

Table 1 shows the testing result of the electrical insulating material according to the four formulations 1-4 as discussed in Examples 1-4 respectively and the common silicone rubber as a reference. It appears the electrical insulating materials according the above examples present better mechanical properties, dielectric properties compared to the silicone rubber, while meeting the requirement of track and erosion resistance.

TABLE 1

| | Sili- | Formu- | Formu- | Formu- | Formu- |
|---|---|---|---|---|---|
| | cone | lation | lation | lation | lation |
| properties | rubber | 1 | 2 | 3 | 4 |
| Tensile strength | 4.5 | 4.8 | 6.6 | 4.9 | 6.8 |
| (MPa) | | | | | |
| (ASTM D412) | | | | | |
| Elongation (%) | 280 | 350 | 600 | 380 | 650 |
| (ASTM D412) | | | | | |
| Dielectric | 22 | 24 | 27 | 25 | 28 |
| breakdown | | | | | |
| strength | | | | | |
| (kV/mm) | | | | | |
| (IEC 60243) | | | | | |
| Track & erosion | pass | pass | pass | pass | pass |
| (1A 3.5 kV) | | | | | |
| (IEC 60587) | | | | | |

Though the present disclosure has been described with reference to the currently considered embodiments, it should be appreciated that the present disclosure is not limited the disclosed embodiments. On the contrary, the present disclosure is intended to cover various modifications and equivalent arrangements falling within in the spirit and scope of the appended claims. The scope of the appended claims is accorded with broadest explanations and covers all such modifications and equivalent structures and functions.

In the claims:

1. An electrical insulating material, comprising:
a matrix component, a filler component and a liquid hydrophobic component;
wherein the matrix component comprises a saturated styrenic block copolymer.

2. The electrical insulating material according to claim 1, wherein the saturated styrenic block copolymer comprises styrene-ethylene-butylene-styrene block copolymer (SEBS), styrene-ethylene-propyl-styrene block copolymer (SEPS) or the mixture thereof.

3. The electrical insulating material according to claim 1, wherein the amount of the filler component is at most 85% of the total weight of the electrical insulating material.

4. The electrical insulating material according to claim 1, wherein the filler component comprises tracking and erosion resistance fillers.

5. The electrical insulating material according to claim 4, wherein the amount of the liquid hydrophobic component is in the range from 1%-15% of the total weight of the electrical insulating material, and
the filler component further comprises fillers for absorbing the liquid hydrophobic component.

6. The electrical insulating material according to claim 4, wherein the tracking and erosion resistance fillers contain one or more material in the group consisting of: natural purified sands, silicon oxides, silicon hydroxides, aluminum oxides, aluminum hydroxides, titanium oxides, titanium hydroxides, zinc borate, zinc oxides, zinc hydroxides, silicates, silicon aluminosilicates and mineral carbonates.

7. The electrical insulating material according to claim 5, wherein the fillers for absorbing the liquid hydrophobic component contain one or more material in the group consisting of: geopolymers, nano silica, glass, mica, ceramic particles and organic fillers.

8. The electrical insulating material according to claim 1, wherein the filler component has an average grain size in the range from 1.0 μm to 200 μm.

9. The electrical insulating material according to claim 1, wherein the electrical insulating material further contains an additive component, and the additive component comprises at least one of the followings: antioxidants, compatibilizers, plasticizers, tougheners and UV stabilizers.

10. The electrical insulating material according to claim 9, wherein the amount of the additive component is in the range from 0.1%-10% of the total weight of the electrical insulating material.

11. The electrical insulating material according to claim 1, wherein the liquid hydrophobic component contains one or more material in the group consisting of:
liquid fluorinated or chlorinated hydrocarbons which contain —CH₂-units, —CHF-units, —CF₂-units, —CF₃-units, —CHCl-units, —C(Cl)₂-units, and/or —C(Cl)₃-units; and a cyclic, linear or branched liquid organopolysiloxane.

12. The electrical insulating material according to claim 11, wherein the liquid hydrophobic component has a viscosity in the range from 50 cSt to 10000 cSt, measured in accordance with DIN 53 019 at 20° C.

13. The electrical insulating material according to claim 11, wherein the liquid organopolysiloxane corresponds to the general fomula (III): 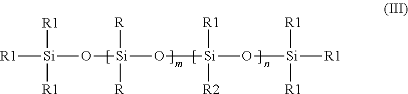
in which
R independently of each other is an unsubstituted or chlorinated or fluorinated alkyl radical having from 1 to 8 carbon atoms, (C₁-C₄- alkyl)aryl, or aryl;
R1 independently at each occurrence has one of the definitions of R or R2, it being possible for two terminal substitutes R1, attached to different Si atoms, being taken together to be an oxygen atom (=cyclic compound);
R2 has one of the definitions of R, or is hydrogen or a radical —(A)r—CH═CH₂;
A is a radical —CsH₂s—, where
s is an integer from 1 to 6;
r is zero or one;
m is from zero to 5000;
n is from zero to 100;
the sum of [m+n] for non-cyclic compounds being at least 20, and the sequence of the groups —[Si(R)(R)O]— and —[Si(R1)(R2)O]— in the molecule being arbitrary.

14. The electrical insulating material according to claim 13, wherein the amount of the liquid organopolysiloxane is in the range from 0.1%-15% of the total weight of the electrical insulating material.

15. A method for preparing an electrical insulating element with an electrical insulating material, comprising:
a) providing the electrical insulating material, comprising a matrix component, a filler component and a liquid hydrophobic component;
wherein the matrix component comprises a saturated styrenic block copolymer;
b) mixing each component of the electrical insulating material in any desired sequence to get a mixture;
c) putting the mixture from step b) into a Brabender mixer or extruder to be blended in a molten state;
d) cutting the mixture from step c) into pellets; and
e) putting the pellets from step d) into an injection moulding machine to produce a desired shape of the electrical insulating element.

16. (New The electrical insulating material according to claim 1, wherein the amount of the filler component is in the range from 50% to 70% of the total weight of the electrical insulating material,

17. The electrical insulating material according to claim 1, wherein the filler component has an average grain size in the range from 5 μm to 35 μm.

18. The electrical insulating material according to claim 11, wherein the liquid hydrophobic component has a viscosity in the range from 40 cSt to 1000 cSt, measured in accordance with DIN 53 019 at 20° C.

19. The electrical insulating material according to claim 13, wherein the amount of the liquid organopolysiloxane is in the range from 5% to 10%, of the total weight of the electrical insulating material.

20. The electrical insulating material according to claim 2, wherein the electrical insulating material further contains an additive component, and the additive component comprises at least one of the followings: antioxidants, compatibilizers, plasticizers, tougheners and UV stabilizers.
